(19) United States
(12) Patent Application Publication
(10) Pub. No.: US 2014/0310083 A1
(43) Pub. Date: Oct. 16, 2014

(54) Edupon System And Method

(71) Applicant: Purna Chander Ramini, Bentonville, AR (US)

(72) Inventor: Purna Chander Ramini, Bentonville, AR (US)

(21) Appl. No.: 14/211,492

(22) Filed: Mar. 14, 2014

Related U.S. Application Data
(60) Provisional application No. 61/802,423, filed on Mar. 16, 2013.

(51) Int. Cl. G06Q 30/02; G06Q 50/20

(52) U.S. Cl. CPC G06Q 30/0225; G06Q 50/20
USPC 705/14.26; 705/14.1

(57) ABSTRACT

Edupon is a type of a discount system on the merchandise items or services, where it splits total discount amount of offer between promotor/fundraiser/marketer and the customer/purchaser/user of the Edupon. It embeds the identity of the promotor/fundraiser/marketer along with the offer information. When printed or electronic Edupon is used during purchase of the merchandise item or service, offer is activate in the computer based platform and records the information in it for offer fund(money) disbursement for both promotor/fundraiser/marketer and customer/purchaser/user.

### BACKGROUND

Student population during their school and college days perform lot of fundraising events for various reasons and sell products or services to their friends, family and relatives. They are rewarded for the same in with toys/games/money etc., which give them some temporary pleasure. Parents purchase lot of products & services using discount offers. Edupon (System And Method) is the attempt to encourage students & parents to use these small amounts gained through fundraisers, part of discounts offers and use the money to deposit in student educational saving accounts.

### SUMMARY

Users of Edupon (System & Method) register and create account in Web based computer system/platform to get a unique ID. Merchants/Vendors/Manufacturers create discount offers with expiry date, number of available offers, split ratio and product information. Registered users of the Edupon (System & Method) can login to their online accounts and view, select, create and use available Edupons. When Edupon is created for the registered user, it embeds a unique ID which (encrypted) includes registered users unique ID, and offer information. When this printed/electronic Edupon is used during the purchase of product or a service, purchaser is given their portion of the discount amount and registered user whose unique ID is embedded in the Edupon is given their portion of the discount amount, that can be deposited in their educational saving account in any authorized bank.

### GENERAL DESCRIPTION OF DRAWINGS

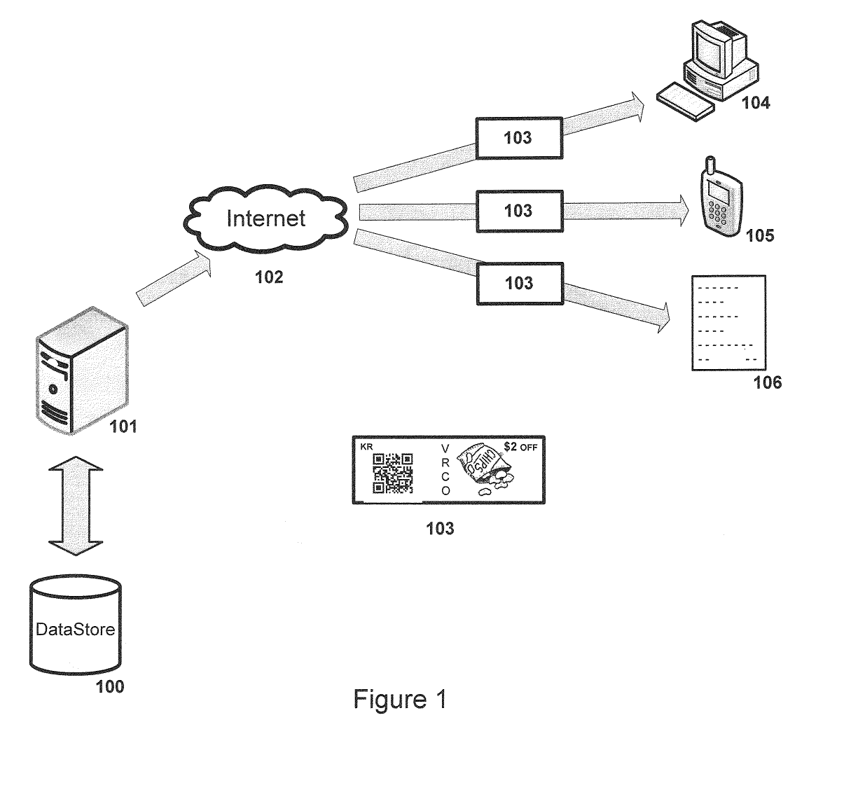

In FIG. 1, item 100 is DataStore, that stores registered users information including their unique ID, discount offers details.

In FIG. 1, item 101 is the web based computer system/platform that manages Edupons, registered users, registered Merchants/Vendors/Manufacturers and discount offers. It only creates set number of Edupons that are determined by the Merchant/Vendor/Manufacturer during the creation of the offer.

In FIG. 1, item 102 is the public internet that enables the communications between all the parties and devices that are involved in Edupon System & Method.

In FIG. 1, item 103 is Edupon that is created by the registered user that can be delivered to computer, smartphone or through email. As shown in the details, QR code embeds ID that uniquely identifies registered user, offer details and importantly discount split between registered user & discount offer during purchase. It displays product information in form of a picture, purchase discount amount in clear text, company/vendor/manufacturer name and registered users initials. Each Edupon that is created only works for one purchase, same Edupon will not work for next purchase as the first purchase is record in the system identified by item 101 in FIG. 1.

In FIG. 1, items 104 is a computer, 105 is a smart phone & 106 is email where created Edupon is delivered for its usage during the purchase of the product or a service.

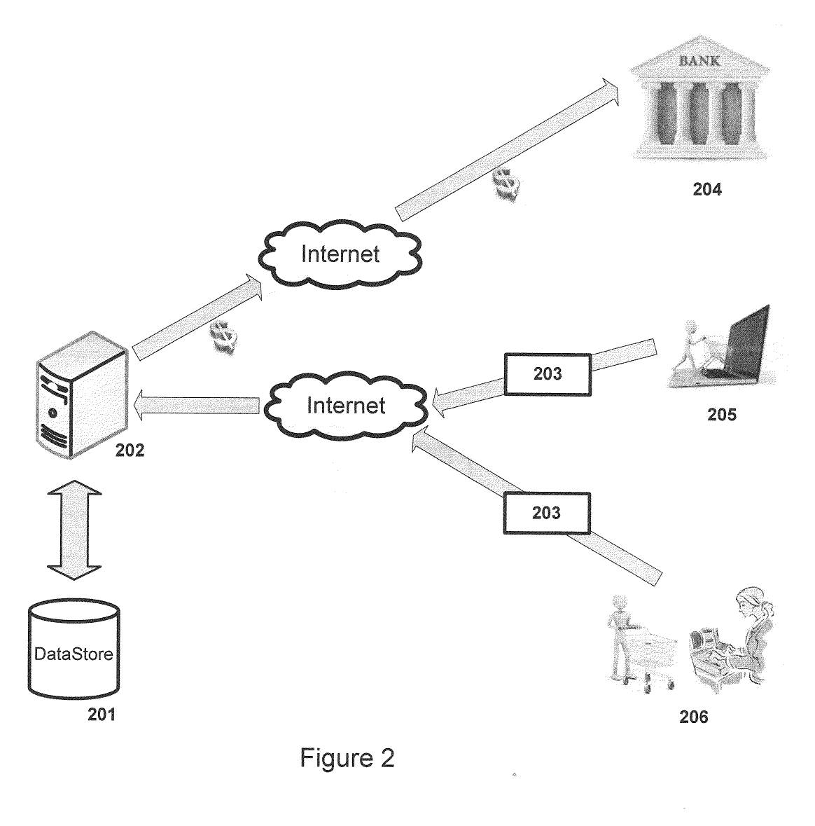

In FIG. 2, item 201 is a DataStore which is same as item 100 in FIG. 1.

In FIG. 2, item 202 is same as described in FIG. 1 & item 101.

In FIG. 2, item 204 is a bank where registered users educational savings account resides.

in FIG. 2, item 203 is Edupon that is used during online or store purchase.

In FIG. 2, item 205 is online web store where purchase is made using Edupon that is created earlier.

In FIG. 2, item 206 is a physical store where purchase is made using Edupon that is created earlier.

### GENERAL DESCRIPTION OF EMBODIMENTS

In FIG. 1, It is shown how Edupon is created and delivered through various ways for the purpose of its usage during the purchase. First the user has to register to use the system. With the information provided during the registration process, unique ID is created for every user. Every Edupon created will have a unique ID that embeds registered users unique id and the offer information. A sample Edupon is also shown in the item 103.

In FIG. 2, it is shown how Edupon is used during the purchase. During purchase on online store or a physical store, Edupon is used. This triggers the process of sending the usage information to the Edupon System/Platform that records this information. On subsequent validation and authorization, the amount of money that is previously identified for registered user is sent to his/her bank to be deposited into their educational savings account.

1. Embedded unique ID that identifies registered user and offer information is unique.

2. Splitting the discount offer between the registered user and the purchaser is unique.

3. Invalidating the second time usage of a particular Edupon that is created with a particular discount offer and registered user is unique.

4. Restricting the creation and usage of discount offers (Edupons) to specific number based on company/manufacturer/vendor specification is unique.
